(19) United States
(12) Patent Application Publication
(10) Pub. No.: US 2024/0151332 A1
(43) Pub. Date: May 9, 2024

(54) O-RING BELLOWS CONNECTION ASSEMBLY WITH OPTIONAL HEAT SHIELD AND LOCK AND SEAL FOR BELLOWS TUBE

(71) Applicant: Flexible Metal, Inc., Hamburg, MI (US)

(72) Inventor: Michael Goodrich, Cumming, GA (US)

(21) Appl. No.: 18/504,207

(22) Filed: Nov. 8, 2023

Related U.S. Application Data
(60) Provisional application No. 63/423,532, filed on Nov. 8, 2022.
(60) Provisional application No. 63/430,702, filed on Dec. 7, 2022.
(60) Provisional application No. 63/432,275, filed on Dec. 13, 2022.

(51) Int. Cl. F16L 17/02

(52) U.S. Cl. CPC F16L 17/02

(57) ABSTRACT

An improved connection apparatus for connecting a tube bellows to a spigot for a battery pack (of an electric vehicle “EV”) having a heat deflector including an outer sleeve and a wire mesh ring. The spigot is connected to a battery pack in an EV having a cooling system. The cooling spigot of the EV is configured to accept a flow of glycol to cool the battery. The connector of the bellows of the present application adds an o-ring groove to the bottom of the spigot. The apparatus is then hydroformed to include internal o-ring grooves and corresponding o-rings are positioned into those grooves. The top o-ring groove seals in a typical o-ring application and the bottom o-ring groove acts as a lock. When the cup assembly is pressed onto the spigot, the o-rings compress as part of their normal function when using o-rings as it moves down the spigot.

### CROSS REFERENCE TO RELATED APPLICATIONS

This patent application claims priority to U.S. Provisional Patent Application No. 63/423,532, filed on Nov. 8, 2022, to U.S. Provisional Patent Application No. 63/430,702, filed on Dec. 7, 2022, and to U.S. Provisional Patent Application No. 63/432,275, filed on Dec. 13, 2022.

The disclosure of the prior application is considered part of and is incorporated by reference into this patent application.

### TECHNICAL FIELD

The present specification generally relates to bellows tubes and, more specifically, to an improved bellows tube connection and having a heat shield and lock and seal o-ring when connected.

### BACKGROUND

Typically, a bellows tube having a smooth connection portion connects directly to a spigot. This connection lacks a locking feature and can be inadvertently removed. As illustrated by FIGS. 1 and 2, the prior art uses a spacer, a bellows tube 104, a cup 106, an o-ring and o-ring retaining lock 110 to slip over the spigot. The black spacer goes into the cup first, then the o-ring 108 then the black retaining clip 110 to hold the o-ring in place. This system works to hold the o-ring but there is nothing positively locking the connection in place to the spigot which may result in the connection to the battery pack 100 being disconnected. In this embodiment, there is no means to dissipate heat from the system in the case of an external heat source. In this arrangement, there is no heat shield or thermal protection. Heat shields are important to prevent excess heat from melting the o-ring and compromising the seal. There is a need for thermal protection of the o-ring seals so as to prevent melting of the o-rings, where the o-rings are integral in maintain the seal. The cooling system, which includes a formed bellows and the o-rings, is part of the system that manages that situation. Preventing or delaying the o-rings from melting keeps the cooling system operational longer giving the battery management system more time to react.

Accordingly, there exists a need in the art to provide an improved bellows tube overcoming the aforementioned disadvantages.

### SUMMARY

The present specification describes an improved O-Ring Bellows Connection Assembly for connecting a bellows tube to a spigot, particularly for use in battery packs of electric vehicles. The assembly includes an o-ring groove at the bottom of the spigot and internal o-ring grooves hydroformed onto the bellows tube. When the cup assembly of the bellows tube is pressed onto the spigot, the o-rings compress and lock the connection in place, while also providing sealing functionality. Additionally, a heat shield comprising an outer sleeve and a wire mesh ring is provided to minimize heat transfer and prevent damage to the o-rings. The assembly provides improved locking, sealing, and thermal protection while reducing costs and increasing serviceability. Various embodiments of the assembly are also disclosed, including those with multiple o-rings, spacers, and retaining clips. The claims define the scope of the invention and cover various modifications and embodiments thereof.

An improved connection apparatus for connecting a tube bellows to a spigot for a battery pack (of an electric vehicle). In the present embodiment, the spigot is connected to a battery pack in an electric vehicle having a cooling system. The cooling spigot of the EV is configured to accept a flow of glycol to cool the battery. pack. The connector of the bellows of the present application adds an o-ring groove to the bottom of the spigot. The apparatus is then hydroformed to include internal o-ring grooves and corresponding o-rings are positioned into those grooves. The top o-ring groove acts the seal in a typical o-ring application and the bottom o-ring groove acts as a lock. When the cup assembly is pressed onto the spigot, the o-rings compress as part of their normal function when using o-rings as it moves down the spigot. When the two bottom o-ring grooves line up (the one in our cup and the one on the spigot) the o-ring is shared between the grooves. The o-ring is half in the spigot groove and half in the cup groove and basically acting as lock. The o-ring is not necessarily sealing (although it could be) but the o-ring is acting as lock preventing the cup from being pulled off. The top o-ring acts as a typical o-ring seal.

In the present embodiment, a heat shield is also provided. A heat deflection shield around the outside of the cup holding the o-rings as disclosed herein. A thin wall stainless steel outer sleeve attached (spot welded or mechanical attachment) to a low-density wire mesh ring that fits circumferentially on the outside of the o-ring retaining cup. The exterior of the stainless steel sleeve is exposed to heat, but because of the air gap created between the sleeve and retaining cup, the heat transfer is minimized, thus allowing the o-rings to survive longer.

The low-density wire mesh acts as the spacer and structural member to create the air gap and support the shield. Because the wire mesh ring is low density, there is minimal heat conducted to the o-ring retaining cup. The mesh ring will easily expand when sliding over the top of the o-ring bumps. Once the outer sleeve is slid over the wire mesh ring and attached, the shield and mesh ring assembly will be fixed in place.

An improved connection apparatus for connecting a tube bellows to a spigot for a battery pack (of an electric vehicle) having a heat deflector including an outer sleeve and a wire mesh ring. In the present embodiment, the spigot is connected to a battery pack in an electric vehicle having a cooling system. The cooling spigot of the EV is configured to accept a flow of glycol to cool the battery pack. The connector of the bellows of the present application adds an o-ring groove to the bottom of the spigot. The apparatus is then hydroformed to include internal o-ring grooves and corresponding o-rings are positioned into those grooves. The top o-ring groove acts the seal in a typical o-ring application and the bottom o-ring groove acts as a lock. When the cup assembly is pressed onto the spigot, the o-rings compress as part of their normal function when using o-rings as it moves down the spigot. When the two bottom o-ring grooves line up (the one in our cup and the one on the spigot) the o-ring is shared between the grooves. The o-ring is half in the spigot groove and half in the cup groove and basically acting as lock. The o-ring is not necessarily sealing (although it could be) but the o-ring is acting as lock preventing the cup from being pulled off. The top o-ring acts as a typical o-ring seal.

### BRIEF DESCRIPTION OF THE DRAWINGS

The embodiments set forth in the drawings are illustrative and exemplary in nature and not intended to limit the subject matter. The following detailed description of the illustrative embodiments can be understood when read in conjunction with the following drawings, where like structure is indicated with like reference numerals and in which:

FIG. 1 depicts a photographic perspective view of the battery pack having spigots for a glycol cooling according to one or more embodiments shown and described herein;

FIG. 2 depicts an exploded perspective photographic view of the bellows tube according to one or more embodiments shown and described herein;

FIG. 3 depicts a perspective photographic view of the battery back with the bellows according to one or more embodiments shown and described herein;

FIG. 4 depicts a side view of the hydroformed bellows having internal o-ring grooves according to one or more embodiments shown and described herein;

FIG. 5 depicts a cross-sectional view of the hydroformed bellows having internal o-ring grooves according to one or more embodiments shown and described herein;

FIG. 6 depicts a side view of the spigot of the EV battery pack having the o-ring groove according to one or more embodiments shown and described herein;

FIG. 7 depicts a side and partial perspective view of the hydroformed bellows having internal o-ring grooves installed on the spigot of the EV battery pack according to one or more embodiments shown and described herein;

FIG. 8 depicts a cross sectional view of the o-ring lock with a heat shield wire mesh ring according to one or more embodiments shown and described herein;

FIG. 9 depicts a cross sectional view of the heat shield assembly with a heat shield wire mesh ring according to one or more embodiments shown and described herein;

FIG. 10 depicts a photographic exemplary model of the heat shield ring according to one or more embodiments shown and described herein;

FIG. 11 depicts a cross-sectional schematic of an alternative embodiment of the ring lock and seal according to one or more embodiments shown and described herein;

FIG. 12 depicts a cross-sectional schematic of another alternative embodiment of the -ring lock and seal according to one or more embodiments shown and described herein; and

FIG. 13 depicts a cross-sectional schematic of yet another alternative embodiment of the -ring lock and seal according to one or more embodiments shown and described herein.

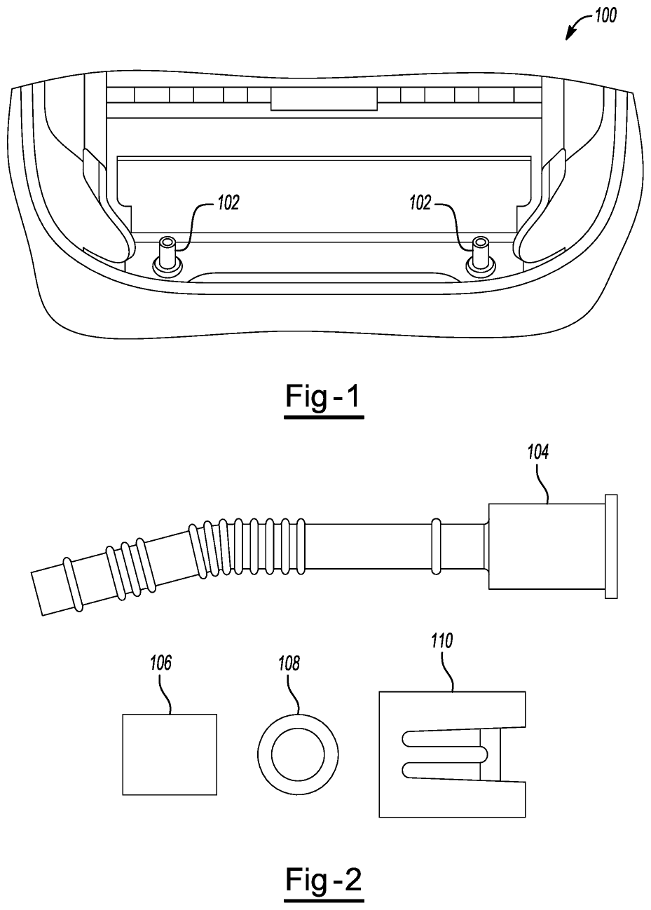

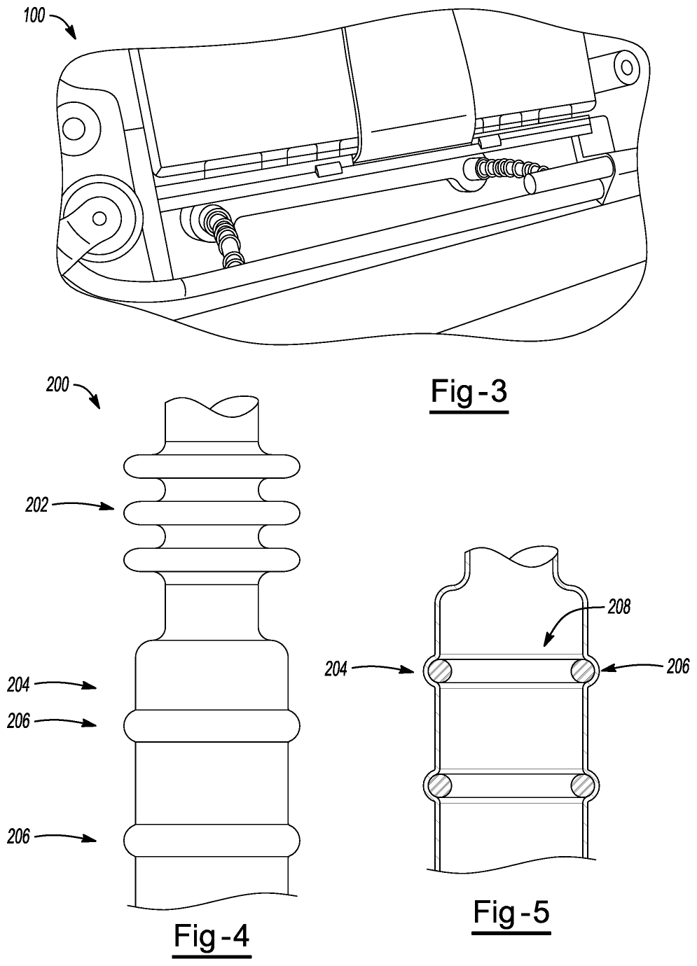

### DETAILED DESCRIPTION

The present system as disclosed is an improved connection apparatus for connecting a tube bellows to a spigot for a battery pack (of an electric vehicle), including a heat shield adapted to incorporate within the system. In the present embodiment, the spigot is connected to a battery pack in an electric vehicle having a cooling system. The cooling spigot of the EV is configured to accept a flow of glycol to cool the battery. pack. The connector of the bellows of the present application adds an o-ring groove to the bottom of the spigot. The apparatus is then hydroformed to include internal o-ring grooves and corresponding o-rings are positioned into those grooves. The top o-ring groove acts the seal in a typical o-ring application and the bottom o-ring groove acts as a lock. When the cup assembly is pressed onto the spigot, the o-rings compress as part of their normal function when using o-rings as it moves down the spigot. When the two bottom o-ring grooves line up (the one in our cup and the one on the spigot) the o-ring is shared between the grooves. The o-ring is half in the spigot groove and half in the cup groove and basically acting as lock. The o-ring is not necessarily sealing (although it could be) but the o-ring is acting as lock preventing the cup from being pulled off. The top o-ring acts as a typical o-ring seal.

The battery pack 100 generally includes a pair of spigots 102. In the prior art, a bellows tube 104 is provided with connection parts being a spacer, a bellows tube 104, a cup 106, an o-ring and o-ring retaining lock 110 to slip over the spigot. The black spacer goes into the cup first, then the o-ring 108 then the black retaining clip 110 to hold the o-ring in place. This system works to hold the o-ring but there is nothing positively locking the connection in place to the spigot which may result in the connection to the battery pack 100 being disconnected.

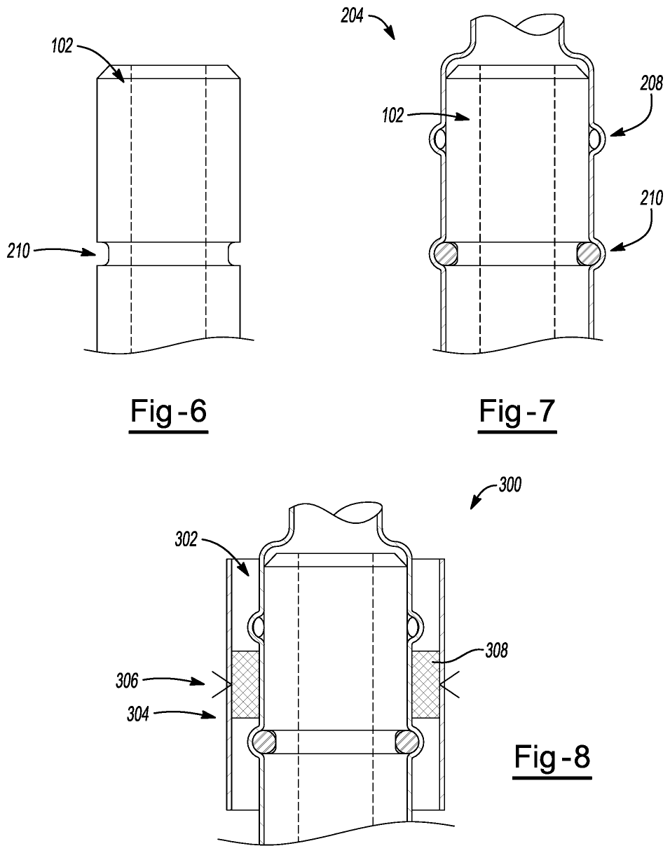

In the improved embodiments of FIGS. 4-7, a bellows tube 200 is provided having a hydroformed bellows portion 202 and a connection portion 204 having a plurality of hydroformed internal o-ring grooves 206. The internal O-ring grooves 206 include o-rings 208.

The spigot 102 of the battery pack includes a roll formed o-ring groove 210. Glycol coolant moves through the spigot 102 to the battery pack. When connected, an o-ring lock is formed (see FIG. 7). When the cup assembly (connection 204) is pressed onto the spigot 102 having the roll formed o-ring groove 210, the o-rings compress as part of their normal function when using o-rings as it moves down the spigot 102. When the two bottom o-ring grooves 206 line up (the one in our cup and the one on the spigot), the o-ring is shared between the grooves. The o-ring is half in the spigot groove and half in the cup groove and basically acting as lock. The o-ring is not necessarily sealing (although it could be) but the o-ring is acting as lock preventing the cup from being pulled off. The top o-ring acts as a typical o-ring seal.

The invention of the present application provides significant benefits and improvements of the prior art. The design as disclosed herein provides for an easy assembly with no additional movements needed to lock the cup to the spigot. Cost is reduced by eliminating parts and labor. Further, there is a positive locking in place when installed. During installation, tactile feedback to the operator that the part was locked in place. Further, sealing is improved (by at least providing some redundancy in the seal). Service-ability is maintained with a certain amount of high removal force the lock can be overcome.

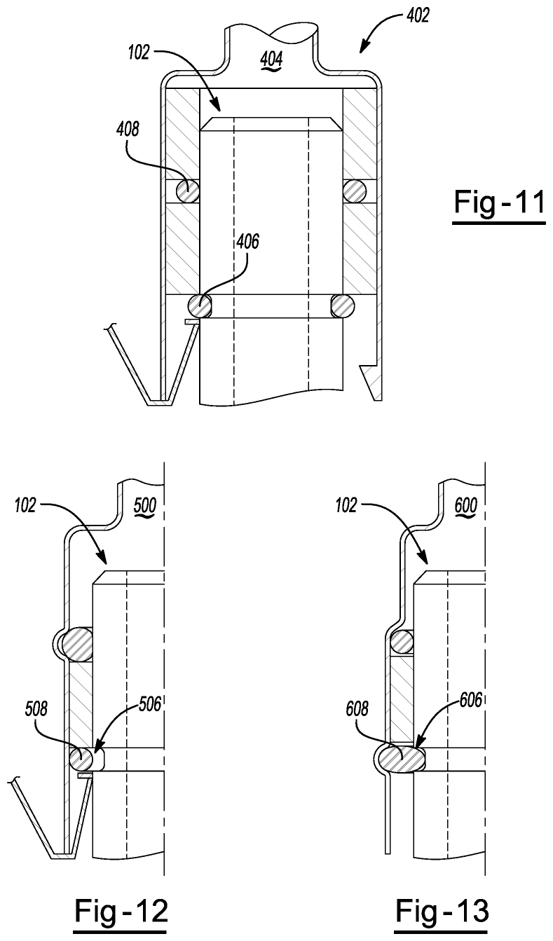

In other embodiments as illustrated, but not limited to, in FIGS. 11-13. These embodiments show that there are numerous arrangements of the number or o-ring(s), spacers, clip (or no clip), and a cup. Further, the assembly may include only 1 o-ring (to seal and/or lock) or may include more than 2 o-rings (to further support locking and/or sealing functionality).

Any of the embodiments as shown in any of the figures may also include a heat deflector, or multiple heat deflectors, such as discussed in the following paragraphs. Any of the embodiments may be in different variations of configurations, series, or quantities but will each consist generally of a spigot (or other first tube), a bellows tube, and at least one o-ring.

In FIG. 11, another illustrative embodiment is provided. A bellows tube 400 is provided having a hydroformed bellows portion 402 and a connection portion 404. Internal 0-ring grooves 406 on a spigot 102 include o-rings 408. The spigot 102 of the battery pack includes a roll formed o-ring groove 406. Glycol coolant moves through the spigot 102 to the battery pack. When connected, an o-ring lock is formed. When the cup assembly (connection 404) is pressed onto the spigot 102 having the roll formed o-ring groove, the o-rings compress as part of their normal function when using o-rings as it moves down the spigot 102. In this embodiment, spacers are provided along with a retaining clip.

In FIG. 12, another illustrative embodiment is provided. A bellows tube 500 is provided having a clip portion having an o-ring receiver. The o-ring received connects to a second clip positioned around the spigot 102. Internal 0-ring grooves 506 on a spigot 102 include o-rings 508. The spigot 102 of the battery pack includes a roll formed o-ring groove 506. Glycol coolant moves through the spigot 102 to the battery pack. When connected, an o-ring lock is formed. When the cup assembly is pressed onto the spigot 102 having the roll formed o-ring groove, the o-rings compress as part of their normal function when using o-rings as it moves down the spigot 102. In this embodiment, a single spacer is provided spacers are provided along with a retaining clip.

In FIG. 13, another illustrative embodiment is provided. A bellows tube 600 is provided having a clip portion having an o-ring receiver. The o-ring received connects to a second clip positioned around the spigot 102. Internal 0-ring grooves 606 on a spigot 102 include o-rings 608. The spigot 102 of the battery pack includes a roll formed o-ring groove 606. Glycol coolant moves through the spigot 102 to the battery pack. When connected, an o-ring lock is formed. In the present embodiment, the cup assembly of the bellows tube includes at least one o-ring groove to accommodate the at least one o-ring positioned around the spigot 102. When the cup assembly is pressed onto the spigot 102 having the roll formed o-ring groove, the o-rings compress as part of their normal function when using o-rings as it moves down the spigot 102. In this embodiment, a single spacer is provided spacers are provided along with a retaining clip. A plurality of spacers may also be provided.

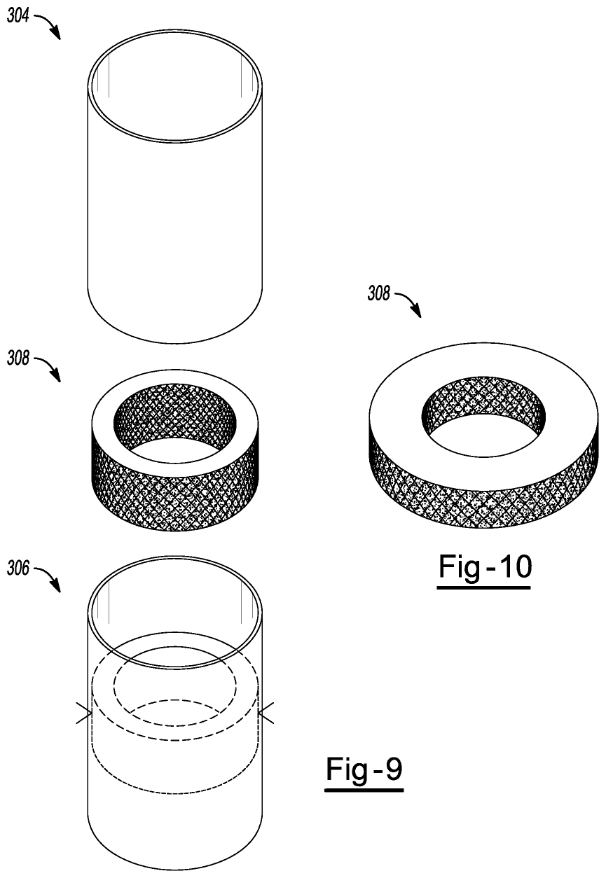

As shown in FIGS. 8-10, in the assembly 300 with a heat deflector, a heat deflection shield 308 around the outside of the cup holding the o-rings as disclosed herein. A thin wall stainless steel outer sleeve 304 attached (spot welded or mechanical attachment 306) to a low-density wire mesh ring that fits circumferentially on the outside of the o-ring retaining cup. The exterior of the stainless steel sleeve 304 is exposed to heat, but because of an air gap 302 created between the sleeve 304 and retaining cup, the heat transfer is minimized, thus allowing the o-rings to survive longer. The low-density wire mesh 308 acts as the spacer and structural member to create the air gap and support the shield. Because the wire mesh ring 308 is low density, there is minimal heat conducted to the o-ring retaining cup. The mesh ring will easily expand when sliding over the top of the o-ring bumps. Once the outer sleeve 304 is slid over the wire mesh ring 308 and attached, the shield 304 and mesh ring 308 assembly will be fixed in place.

The benefits of incorporating the heat deflection include the wherein the air gap thermal barrier prevents or delays the o-rings from melting, it's a mechanically self-supporting system, very cost effective, and heat transfer through the contact points is small due to the low density/minimal contact wire mesh ring. These improve increase both safely and performance of the electrical vehicle battery while being cost effective to implement.

Example Clause A: A connector assembly having: a first tube; a bellows tube, the bellows tube having a cup at the distal end of the bellows tube; at least one o-ring, the o-ring disposed around the outer circumference of the first tube; and the cup positioned over spigot and the at least one o-ring wherein the o-ring seals and/or locks the bellows tube to the first tube.

Example Clause B: The connector assembly of Example Clause A, wherein a heat shield is positioned around the first tube and adjacent to the at least one o-ring.

Example Clause C: The connector assembly of Example Clause A or Example Clause B, wherein a spacer is provided around the first tube and adjacent to the at least one o-ring.

Example Clause D: The connector assembly of any one of Example Clauses A-C, wherein 2 o-rings are provided to lock and/or seal the connector assembly.

Example Clause E: The connector assembly of any one of Example Clauses A-D, wherein a single o-ring is provided to lock and/or seal the connector assembly.

Example Clause F: The connector assembly of any one of Example Clauses A-E, wherein a plurality of o-rings are provided to lock and/or seal the connector assembly.

Example Clause G: A connector assembly comprising: a spigot; a bellows tube, the bellows tube having a cup at the distal end of the bellows tube; at least one o-ring, the o-ring disposed around the outer circumference of the spigot; and the cup positioned over spigot and the at least one o-ring wherein the o-ring seals and/or locks the bellows tube to the spigot.

Example Clause H: The connector assembly of Example Clause G, wherein a heat shield is positioned around the spigot and adjacent to the at least one o-ring.

Example Clause I: The connector assembly of Example Clause G or Example Clause H, wherein a spacer is provided around the spigot and adjacent to the at least one o-ring.

Example Clause J: The connector assembly of any one of Example Clauses G-I, wherein 2 o-rings are provided to lock and/or seal the connector assembly.

Example Clause K: The connector assembly of any one of Example Clauses G-J, wherein a single o-ring is provided to lock and/or seal the connector assembly.

Example Clause L: The connector assembly of any one of Example Clauses G-K, wherein a plurality of o-rings are provided to lock and/or seal the connector assembly.

Example Clause M: The connector assembly of any one of Example Clauses G-L wherein aa retaining clip is provided around the connector assembly.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

It is noted that the terms “substantially” and “about” may be utilized herein to represent the inherent degree of uncertainty that may be attributed to any quantitative comparison, value, measurement, or other representation.

These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the Detailed Description of the Invention of a range in terms of at “‘x’ parts by weight of the resulting polymeric blend composition” also contemplates a teaching of ranges of same recited amount of “x” in percent by weight of the resulting polymeric blend composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The term “consisting essentially of” to describe a combination shall include the elements, ingredients, components, or steps identified, and such other elements ingredients, components or steps that do not materially affect the basic and novel characteristics of the combination. The use of the terms “comprising” or “including” to describe combinations of elements, ingredients, components, or steps herein also contemplates embodiments that consist essentially of, or even consist of the elements, ingredients, components or steps.

Plural elements, ingredients, components, or steps can be provided by a single integrated element, ingredient, component or step. Alternatively, a single integrated element, ingredient, component, or step might be divided into separate plural elements, ingredients, components or steps. The disclosure of “a” or “one” to describe an element, ingredient, component, or step is not intended to foreclose additional elements, ingredients, components or steps. All references herein to elements or metals belonging to a certain group refer to the Periodic Table of the Elements published and copyrighted by CRC Press, Inc., 1989. Any reference to the group or groups shall be to the group or groups as reflected in this Periodic Table of the Elements using the IUPAC system for numbering groups.

While particular embodiments have been illustrated and described herein, it should be understood that various other changes and modifications may be made without departing from the spirit and scope of the claimed subject matter.

Moreover, although various aspects of the claimed subject matter have been described herein, such aspects need not be utilized in combination.

It is therefore intended that the appended claims (and/or any future claims filed in any utility application) cover all such changes and modifications that are within the scope of the claimed subject matter.

Moreover, although various aspects of the claimed subject matter have been described herein, such aspects need not be utilized in combination.

It is therefore intended that the appended claims cover all such changes and modifications that are within the scope of the claimed subject matter.

1. A connector assembly comprising:
a first tube;
a bellows tube, the bellows tube having a cup at the distal end of the bellows tube;
at least one o-ring, the o-ring disposed around the outer circumference of the first tube; and
the cup positioned over spigot and the at least one o-ring wherein the o-ring seals and/or locks the bellows tube to the first tube.

2. The connector assembly of claim 1, wherein a heat shield is positioned around the first tube and adjacent to the at least one o-ring.

3. The connector assembly of claim 1, wherein a spacer is provided around the first tube and adjacent to the at least one o-ring.

4. The connector assembly of claim 1, wherein 2 o-rings are provided to lock and/or seal the connector assembly.

5. The connector assembly of claim 1, wherein a single o-ring is provided to lock and/or seal the connector assembly.

6. The connector assembly of claim 1, wherein a plurality of o-rings are provided to lock and/or seal the connector assembly.

7. A connector assembly comprising:
a spigot;
a bellows tube, the bellows tube having a cup at the distal end of the bellows tube;
at least one o-ring, the o-ring disposed around the outer circumference of the spigot; and
the cup positioned over spigot and the at least one o-ring wherein the o-ring seals and/or locks the bellows tube to the spigot.

8. The connector assembly of claim 7, wherein a heat shield is positioned around the spigot and adjacent to the at least one o-ring.

9. The connector assembly of claim 7, wherein a spacer is provided around the spigot and adjacent to the at least one o-ring.

10. The connector assembly of claim 7, wherein 2 o-rings are provided to lock and/or seal the connector assembly.

11. The connector assembly of claim 7, wherein a single o-ring is provided to lock and/or seal the connector assembly.

12. The connector assembly of claim 7, wherein a plurality of o-rings are provided to lock and/or seal the connector assembly.

13. The connector assembly of claim 7 wherein aa retaining clip is provided around the connector assembly.
